(19) United States
(12) Patent Application Publication
(10) Pub. No.: US 2024/0184223 A1
(43) Pub. Date: Jun. 6, 2024

(54) MANUFACTURING METHOD OF RESIN PARTICLE DISPERSION AND MANUFACTURING METHOD OF ELECTROSTATIC CHARGE IMAGE DEVELOPING TONER

(71) Applicant: FUJIFILM Business Innovation Corp., Tokyo (JP)

(72) Inventors: Satoshi MIURA, Kanagawa (JP); Takahiro YAMASHITA, Kanagawa (JP); Takahisa TATEKAWA, Kanagawa (JP); Yuya KATO, Kanagawa (JP)

(73) Assignee: FUJIFILM Business Innovation Corp., Tokyo (JP)

(21) Appl. No.: 18/307,810

(22) Filed: Apr. 27, 2023

(30) Foreign Application Priority Data
Nov. 25, 2022 (JP) 2022-188724

(51) Int. Cl. G03G 9/08

(52) U.S. Cl. CPC G03G 9/0804; G03G 9/081; G03G 9/08755

(57) ABSTRACT

A manufacturing method of a resin particle dispersion having (A) melt mixing of melting and mixing a resin mixture containing a resin, a pigment having an isoindoline skeleton, and a hydrophobic lubricant to obtain a molten mixture, and (B) emulsification of adding a surfactant and a basic compound to the molten mixture and adding an aqueous medium while applying shearing force in a range of Tm<Te<(Tm+30° C.) to melt and emulsify the molten mixture where Tm represents a softening temperature of the hydrophobic lubricant and Te represents an emulsification temperature.

### CROSS-REFERENCE TO RELATED APPLICATIONS

This application is based on and claims priority under 35 USC 119 from Japanese Patent Application No. 2022-188724 filed Nov. 25, 2022.

### BACKGROUND

### (i) Technical Field

The present invention relates to a manufacturing method of a resin particle dispersion and a manufacturing method of an electrostatic charge image developing toner.

### (ii) Related Art

The manufacturing method of a toner has undergone a transition to the wet manufacturing method of manufacturing particles in a solution or water from the kneading and pulverizing method of the related art, and the wet manufacturing method has become the mainstream method. Examples of the wet manufacturing method include a suspension polymerization method, a dissolution suspension method, an aggregation and coalescence method, and the like.

For example, JP2010-276750A discloses “a manufacturing method of a toner having at least steps including (A) mixing step of mixing together a binder resin containing a polyester having an acid group, a colorant, a basic substance, and a surfactant in an aqueous medium to obtain a mixture, (B) melt emulsification step of applying shearing force while heating the mixture at a temperature higher than a softening temperature (Tm) of the binder resin by 10° C. or more to obtain a melt emulsion, (C) cooling step of cooling the melt emulsion to a temperature equal to or lower than a glass transition temperature (Tg) of the binder resin at a cooling rate of 0.5° C./min or higher and 10° C./min or lower while applying shearing force to prepare a fine particle dispersion having a median diameter of 1.0 μm or less, and (D) step of aggregating the fine particle dispersion in an aqueous medium”.

Furthermore, JP2011-17838A discloses “an electrophotographic toner that is manufactured by a pulverization method or generated in an aqueous medium and contains at least a binder resin and a colorant, in which the colorant is a pigment represented by the following General Formula (1) (in the formula, X and Y each independently represent ═C(CN)—CONH—CH₃ or ═C(CN)—CONH—(C₆H₄)—Z selected from the following structures and the like), and the electrophotographic toner further contains a fatty acid amide compound.”

JP2011-17838A also discloses “as the colorant, a master batch is used which is obtained by melting and kneading the binder resin, the pigment, and the fatty acid amide compound in advance” and “a color index number for the pigment is PY185”.

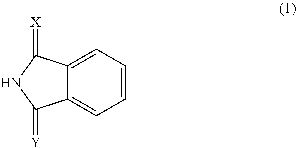

### SUMMARY

Aspects of non-limiting embodiments of the present disclosure relate to a manufacturing method of a resin particle dispersion that has (A) melt mixing of melting and mixing a resin mixture containing a resin and a pigment having an isoindoline skeleton to obtain a molten mixture, and (B) emulsification of adding a surfactant and a basic compound to the molten mixture and adding an aqueous medium while applying shearing force to melt and emulsify the molten mixture, the manufacturing method of a resin particle dispersion being more likely to manufacture an electrostatic charge image developing toner suppressing deterioration of transferability to a thick recording medium, compared to a manufacturing method of a resin particle dispersion in which a hydrophobic lubricant is not added to a resin mixture containing a resin and a pigment having an isoindoline skeleton or a manufacturing method of a resin particle dispersion in which Te does not satisfy a range of Tm<Te<(Tm+30° C.) where Tm represents a softening temperature of a hydrophobic lubricant and Te represents an emulsification temperature.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the above problems include the following aspect.

According to an aspect of the present disclosure, there is provided a manufacturing method of a resin particle dispersion has (A) melt mixing of melting and mixing a resin mixture containing a resin, a pigment having an isoindoline skeleton, and a hydrophobic lubricant to obtain a molten mixture, and

(B) emulsification of adding a surfactant and a basic compound to the molten mixture and adding an aqueous medium while applying shearing force in a range of Tm<Te<(Tm+30° C.) to melt and emulsify the molten mixture where Tm represents a softening temperature of the hydrophobic lubricant and Te represents an emulsification temperature.

### DETAILED DESCRIPTION

The exemplary embodiments as an example of the present invention will be described below. The following descriptions and examples merely illustrate the exemplary embodiments, and do not limit the scope of the invention.

In the present specification, a range of numerical values described using “to” represents a range including the numerical values listed before and after “to” as the minimum value and the maximum value respectively.

Regarding the ranges of numerical values described in stages in the present specification, the upper limit or lower limit of a range of numerical values may be replaced with the upper limit or lower limit of another range of numerical values described in stages. Furthermore, in the present exemplary embodiments, the upper limit or lower limit of a range of numerical values may be replaced with values described in examples.

In the present specification, the term “step” includes not only an independent step but a step which is not clearly distinguished from other steps as long as the intended goal of the step is achieved.

In the present specification, each component may include a plurality of corresponding substances. In a case where the amount of each component in a composition is mentioned in the present exemplary embodiments, and there are two or more kinds of substances corresponding to each component in the composition, unless otherwise specified, the amount of each component means the total amount of two or more kinds of the substances present in the composition.

In the present specification, the description “(meth)acryl” means that either “acryl” or “methacryl” may be used.

In the present specification, an electrostatic charge image developing toner is also simply called “toner”, and an electrostatic charge image developer is also simply called “developer”.

### Manufacturing Method of Resin Particle Dispersion

The manufacturing method of a resin particle dispersion according to the present exemplary embodiment has

(A) melt mixing step of melting and mixing a resin mixture containing a resin, a pigment having an isoindoline skeleton, and a hydrophobic lubricant to obtain a molten mixture, and

(B) emulsification step of adding a surfactant and a basic compound to the molten mixture and adding an aqueous medium while applying shearing force in a range of Tm<Te<(Tm+30° C.) to melt and emulsify the molten mixture where Tm represents a softening temperature of the hydrophobic lubricant and Te represents an emulsification temperature.

By going through the above steps, the manufacturing method of a resin particle dispersion according to the present exemplary embodiment manufacture an electrostatic charge image developing toner suppressing the deterioration of transferability to a thick recording medium. The reason is presumed as follows.

As one of the manufacturing methods of toner particles, for example, an aggregation and coalescence method is known in which resin particles are aggregated and then melted and coalesced. In the aggregation and coalescence method, sometimes resin particles containing a pigment are used.

The pigments having an isoindoline skeleton with high hydrophilicity, which are represented by C. I. Pigment Yellow 185, C. I. Pigment Yellow 139, and the like, are poorly dispersed in resin particles during emulsification for manufacturing resin particles, which hinders the pigment surface from being fully coated with the resin.

Therefore, when the aggregation and coalescence method is performed to manufacture a toner, the pigment is released outside the toner particles without being incorporated into the toner particles. As a result, the pigment adheres to the surface of the toner particles, the transferability deteriorates, (particularly, the transferability to a thick recording medium such as embossed paper deteriorates), and transfer failure occurs.

Although a technique of improving pigment dispersibility in resin particles by controlling emulsification conditions (for example, JP2010-276750A and the like) and a technique of improving pigment dispersibility in resin particles by using a material having high affinity with a pigment and a resin (for example, JP2011-17838A and the like) are also known, it cannot be said that these techniques are satisfactory.

Therefore, in the manufacturing method of a resin particle dispersion according to the present exemplary embodiment, first, a molten mixture to which a resin and a pigment having an isoindoline skeleton are incorporated is obtained. Next, a surfactant and a basic compound are added to the molten mixture, and then high-temperature emulsification is at an emulsification temperature Te in a range of higher than a softening temperature Tm of the hydrophobic lubricant and lower than (softening temperature Tm of hydrophobic lubricant+)30° ° C.

In this way, the hydrophobic lubricant which has high affinity with both the resin and the pigment coats the pigment surface and is interposed between the pigment and the resin. Presumably, as a result, even the pigment having an isoindoline skeleton with high hydrophilicity may be more successfully dispersed in the resin particles, and the pigment surface may be fully coated with the resin.

In addition, presumably, because the pigment surface becomes hydrophobic due to the coating with the hydrophobic lubricant, the pigment may be inhibited from being released outside the toner particles when the aggregation and coalescence method of aggregating resin particles in an aqueous medium is performed to manufacture a toner.

Presumably, the manufacturing method of a resin particle dispersion according to the present exemplary embodiment may manufacture an electrostatic charge image developing toner suppressing the deterioration of transferability to a thick recording medium by going through the above steps, for the above reasons.

Hereinafter, the manufacturing method of a resin particle dispersion according to the present exemplary embodiment will be specifically described.

### Melt Mixing Step

In the melt mixing step, a resin mixture containing a resin, a pigment having an isoindoline skeleton, and a hydrophobic lubricant is melted and mixed to obtain a molten mixture.

### Materials Used in Melt Mixing Step

### Resin

The resin is, for example, a resin that functions as a binder resin for the toner.

Examples of the resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the resin also include non-vinyl-based resins such as an epoxy resin, a polyester resin, a polyurethane resin, a polyamide resin, a cellulose resin, a polyether resin, and modified rosin, mixtures of these with the vinyl-based resins, graft polymers obtained by polymerizing a vinyl-based monomer together with the above resins, and the like.

One of these resins may be used alone, or two or more of these resins may be used in combination.

Among these, from the viewpoint of functioning as a binder resin for the toner, as the resin, for example, a polyester resin is preferable. In a case where the polyester resin is used, the hydrophobic lubricant coats the pigment surface and is interposed between the resin and the pigment, which improves the dispersibility in the resin particles. As a result, the deterioration of transferability is likely to be suppressed.

Examples of the polyester resin include known polyester resins.

Examples of the polyester resin include a polycondensate of a polyvalent carboxylic acid and a polyhydric alcohol. As the polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these, lower alkyl esters (for example, having 1 or more and 5 or less carbon atoms) of these, and the like.

One polyvalent carboxylic acid may be used alone, or two or more polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among these, for example, aromatic diols and alicyclic diols are preferable as the polyhydric alcohol, and aromatic diols are more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One polyhydric alcohol may be used alone, or two or more polyhydric alcohols may be used in combination.

The acid value of the polyester resin is, for example, preferably 10 mgKOH or more and 40 mgKOH or less, more preferably 10 mgKOH or more and 30 mgKOH or less, and even more preferably 15 mgKOH or more and 20 mgKOH or less.

In a case where the acid value of the polyester resin is in the above range, the hydrophobic lubricant coats the pigment surface and is interposed between the resin and the pigment, which improves the dispersibility in the resin particles. As a result, the deterioration of transferability is likely to be suppressed.

The acid value of the polyester resin is a value measured by the neutralization titration method specified in JIS K0070: 1992.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the polyester resin is, for example, preferably 5,000 or more and 1,000,000 or less, and more preferably 7,000 or more and 500,000 or less.

The number-average molecular weight (Mn) of the polyester resin is, for example, preferably 2,000 or more and 100,000 or less.

The molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HCL-8120GPC manufactured by Tosoh Corporation as a measurement device, TSKgel·Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The polyester resin is obtained by a well-known manufacturing method. Specifically, for example, the polyester resin is obtained by a method of setting a polymerization temperature to 180ºC or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is being distilled off. In a case where a monomer with poor compatibility takes part in the reaction, for example, the monomer with poor compatibility may be condensed in advance with an acid or an alcohol that is to be polycondensed with the monomer, and then polycondensed with the major component.

From the viewpoint of homogeneity of mixing and emulsification dispersibility in the emulsification step, the softening temperature of the resin is, for example, preferably 50° C. or higher and 90° C. or lower, and more preferably 50° C. or higher and 80° C. or lower.

The softening temperature of the resin is measured as follows.

A sample weighing 1 g is heated using a flow tester “CFT-500D” (manufactured by Shimadzu Corporation.) at a heating rate of 6° C./min, and in this state, a load of 1.96 MPa is applied thereto by a plunger such that the sample is pushed through a nozzle having a diameter of 1 mm and a length of 1 mm. The descent amount of the plunger of the flow tester is plotted against the temperature, and the temperature at which half of the sample flows out is adopted as the softening temperature.

The amount of the resin is set according to the purpose.

Specifically, the amount of the resin with respect to 100% by mass of the resin mixture is, for example, preferably 40% by mass or more and 90% by mass or less, and more preferably 50% by mass or more and 80% by mass or less.

### Pigment

As the pigment, a pigment having an isoindoline skeleton is used.

Examples of the pigment having an isoindoline skeleton include C. I. Pigment Yellow 185, C. I. Pigment Yellow 139, C. I. Pigment Orange 66, C. I. Pigment Orange 69, C. I. Pigment Red 260, and the like.

Among these, from the viewpoint of color reproducibility and color developing properties, for example, C. I. Pigment Yellow 185 and C. I. Pigment Yellow 139 are preferable as the pigment having an isoindoline skeleton. The structural formula of C. I. Pigment Yellow 185 is shown below. Note that “C. I.” is an abbreviation for “Color Index”.

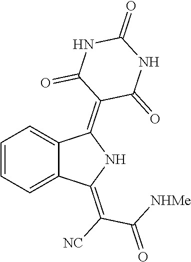 [SMILES: CNC(=O)/C(C#N)=c1\[nH]c(=C2C(=O)NC(=O)NC2=O)c2ccccc12]

As the pigment, the pigment having an isoindoline skeleton and other colorants different from the pigment may be used in combination. Here, the ratio of the pigment having an isoindoline skeleton to the pigment is, for example, preferably 50% by mass or more and 100% by mass (for example, preferably 70% by mass or more and 100% by mass or less).

Examples of other pigments include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

As the pigment, a pigment having undergone a surface treatment as necessary may be used, or a dispersant may be used in combination with the pigment.

One pigment may be used alone, or two or more pigments may be used in combination.

The amount of the pigment is set according to the purpose.

The amount of the pigment with respect to the resin is, for example, preferably 10% by mass or more and 80% by mass or less, and more preferably 10% by mass or more and 60% by mass or less.

### Hydrophobic Lubricant

The hydrophobic lubricant has a function of directly coating at least a part of the surface of the pigment to make the pigment hydrophobic.

Here, “hydrophobic” means the properties of having solubility in water at 25° C. of less than 0.1 g/L.

Examples of the hydrophobic lubricant include lubricants having a hydrocarbon chain having 6 or more and 30 or less carbon atoms (particularly, a long hydrocarbon chain) such as an alkyl chain or an alkenyl chain. In a case where the hydrocarbon chain is linked to a group such as a carboxyl group, the number of carbon atoms of the group such as a carboxyl group is not included in the number of carbon atoms of the hydrocarbon chain.

Particularly, the number of carbon atoms of the hydrocarbon chain of the lubricant having a hydrocarbon chain (particularly a long hydrocarbon chain) is, for example, preferably 10 or more and 30 or less, and more preferably 15 or more and 30 or less.

In a case where the number of carbon atoms of the hydrocarbon chain of the hydrophobic lubricant is in the above range, the hydrophobic lubricant coats the pigment surface and is interposed between the resin and the pigment, which improves the dispersibility in the resin particles. As a result, the deterioration of transferability is likely to be suppressed.

Specific examples of the hydrophobic lubricant include a fatty acid, a fatty acid ester, a fatty acid amide, a higher alcohol, and a fatty acid metal salt. Among these, for example, a fatty acid, a fatty acid ester, a fatty acid amide, and a higher alcohol are preferable.

Examples of the fatty acid include a saturated fatty acid such as behenic acid, stearic acid, palmitic acid, myristic acid, or lauric acid; and an unsaturated fatty acid such as oleic acid, linoleic acid, ricinoleic acid, and erucic acid.

Examples of the fatty acid ester include an ester of the aforementioned saturated or unsaturated fatty acid and an alcohol. Examples of the alcohol include a monohydric alcohol such as methanol, ethanol, propanol, butanol, or 2-ethylhexanol; a polyhydric alcohol such as glycerin, polyglycerin (such as diglycerin), pentaerythritol, ethylene glycol, diethylene glycol, propylene glycol, butylene glycol, trimethylolpropane, trimethylolethane, or a sugar alcohol; and the like.

Examples of the fatty acid amide include a fatty acid monoamide compound, a fatty acid diamide compound, a saturated fatty acid monoamide compound, and an unsaturated fatty acid diamide compound. Specifically, examples of the fatty acid amide include palmitic acid amide, stearic acid amide, oleic acid amide, erucic acid amide, and the like.

Examples of the higher alcohol include henicosanol, tricosanol, tetracosanol, heptacosanol, nonacosanol, hentriacontanol, dotriacontanol, and the like.

Examples of the fatty acid metal salt include a metal salt of the aforementioned saturated or unsaturated fatty acid and a metal such as lithium, magnesium, calcium, barium, or zinc. Specifically, examples of the fatty acid metal salt include magnesium palmitate, magnesium stearate, magnesium oleate, and the like.

The softening temperature of the hydrophobic lubricant is, for example, preferably 60° C. or higher and 100° C. or lower, more preferably 70° C. or higher and 100° C. or lower, and even more preferably 70° C. or higher and 95° C. or lower.

The difference between the softening temperature of the hydrophobic lubricant and the softening temperature of the resin is, for example, more preferably 5° C. or higher and 50° C. or lower, and even more preferably 10° C. or higher and 40° C.

In a case where the softening temperature of the hydrophobic lubricant and the difference between the softening temperature of the hydrophobic lubricant and the softening temperature of the resin are in the above range, the hydrophobic lubricant coats the pigment surface and is interposed between the resin and the pigment, which improves the dispersibility in the resin particles. As a result, the deterioration of transferability is likely to be suppressed.

The softening temperature of the hydrophobic lubricant is measured as follows.

A sample weighing 1 g is heated using a flow tester “CFT-500D” (manufactured by Shimadzu Corporation.) at a heating rate of 6° C./min, and in this state, a load of 1.96 MPa is applied thereto by a plunger such that the sample is pushed through a nozzle having a diameter of 1 mm and a length of 1 mm. The descent amount of the plunger of the flow tester is plotted against the temperature, and the temperature at which half of the sample flows out is adopted as the softening temperature.

The amount of the hydrophobic lubricant with respect to the pigment is, for example, preferably 10% by mass or more and 50% by mass or less, and more preferably 10% by mass or more and 40% by mass or less.

In a case where the amount of the hydrophobic lubricant is in the above range, the hydrophobic lubricant coats the pigment surface and is interposed between the resin and the pigment, which improves the dispersibility in the resin particles. As a result, the deterioration of transferability is likely to be suppressed.

### Conditions for Melt Mixing Step

In the melt mixing step, for example, the resin mixture is melted and mixed, in the absence of an organic solvent or in the presence of an organic solvent in an amount of 10% by mass or less with respect to the resin, and more preferably in the absence of an organic solvent, thereby obtaining a molten mixture.

That is, in both the resin mixture and the molten mixture, the content of an organic solvent is 0% by mass or more and 10% by mass or less.

The organic solvent is an organic solvent that dissolves the resin and is other than an aqueous medium such as an alcohol.

The mixing device for obtaining the resin mixture in the melt mixing step is not particularly limited. Examples thereof include known mixers such as a Henschel mixer, a V-type blender, a Lödige mixer, a ribbon blender, a Plastomill, a tumbler blender, and a low-pressure blender.

From the viewpoint of homogeneity of mixing and emulsification dispersibility in the emulsification step, the mixing temperature for obtaining the resin mixture is, for example, preferably 50° ° C. to 150° C., and more preferably 50° C. to 100° C.

The melt mixing device for obtaining the molten mixture in the melt mixing step is not particularly limited. Examples thereof include a roll mill, a kneader, a pressure kneader, a banbury mixer, a Labo Plastomill, a single-screw or twin-screw extruder, and the like.

From the viewpoint of homogeneity of mixing and emulsification dispersibility in the emulsification step, the melting temperature for obtaining the molten mixture is, for example, preferably a temperature equal to or higher than the softening temperature of the resin, and more preferably a temperature equal to or higher than the softening temperature of the resin+5° C.

### Emulsification Step

In the emulsification step, a surfactant and a basic compound are added to the molten mixture, and an aqueous medium is added in a state where shearing force is applied in a range of Tm<Te<(Tm+30° C.) where Tm represents a softening temperature of the hydrophobic lubricant and Te represents an emulsification temperature, thereby melting and emulsifying the molten mixture.

### Materials Used in Emulsification Step

### Surfactant

Examples of the surfactant include various surfactants such as an anionic surfactant, an amphoteric surfactant, a cationic surfactant, and a nonionic surfactant. Among these, from the viewpoint of fixability and transferability of the obtained toner, for example, an anionic surfactant is preferable, a sulfuric acid ester-type or sulfonic acid-type anionic surfactant is more preferable, and a sulfonic acid-type anionic surfactant is particularly preferable.

As the anionic surfactant, any of the carboxylic acid type, sulfuric acid ester type, sulfonic acid type, and phosphoric acid ester type anionic surfactants can be used. Examples of the anionic surfactant include a fatty acid salt, rosinate, naphthate, ether carboxylate, alkenyl succinate, primary alkyl sulfate, secondary alkyl sulfate, polyoxyethylene alkyl sulfate, polyoxyethylene alkyl phenyl sulfate, monoacylglycerin sulfate, an acylamino sulfuric acid ester salt, sulfonated oil, a sulfonated fatty acid alkyl ester, α-olefin sulfonate, secondary alkane sulfonate, an α-sulfo fatty acid salt, acyl isethionate, dialkyl sulfosuccinate, alkylbenzene sulfonate, alkyl naphthalene sulfonate, alkyl diphenyl ether disulfonate, petroleum sulfonate, lignin sulfonate, alkyl phosphate, polyoxyethylene alkyl phosphate, polyoxyethylene alkyl phenyl phosphate, perfluoroalkyl carboxylate, perfluoroalkyl sulfonate, and a perfluoroalkyl phosphoric acid ester.

An amphoteric surfactant is a surfactant that has both a cation group and an anion group in a molecular structure, and refers to a substance that has charge separation in the molecular structure but does not have a charge as a whole molecule.

Examples of the amphoteric surfactant include N-alkylnitrilotriacetic acid, N-alkyldimethylbetaine, N-alkyloxymethyl-N,N-diethylbetaine, N-alkylsulfobetaine, N-alkylhydroxysulfobetaine, lecithin, and perfluoroalkyl sulfonamide alkyl betaine.

Examples of the cationic surfactant include an N-acylamine salt, a quaternary ammonium salt, and an imidazolium salt. Specific examples thereof include fatty acid polyethylene polyamide, an amide, an alkyl trimethyl ammonium salt, a dialkyl dimethyl ammonium salt, an alkyl dimethyl benzyl ammonium salt, an alkylpyridinium salt, an acylaminoethyl methyl diethyl ammonium salt, an acylaminopropyl dimethyl benzyl ammonium salt, an acylaminopropyl dimethyl hydroxyethyl ammonium salt, an acylaminoethyl pyridinium salt, a diacylaminoethyl ammonium salt, a diacyloxyethyl methyl hydroxyethyl ammonium salt, an alkyloxymethyl pyridinium salt, and a 1-acylaminoethyl-2-alkylimidazolium salt.

Examples of the nonionic surfactant include an ester of a polyhydric alcohol and a fatty acid that are linked by an ester bond, an ether such as a polyoxyethylene alkyl ether or a polyoxyethylene alkyl phenyl ether, polyoxyethylene polyoxypropylene glycol, a fatty acid as an ethylene oxide adduct, a polyhydric alcohol fatty acid ester as an ethylene oxide adduct, fatty acid alkanolamide having a hydrophobic group and a hydrophilic group that are linked by an amide bond, and alkyl polyglycoside.

The anionic surfactant, the amphoteric surfactant, the cationic surfactant, and the nonionic surfactant are not limited to the surfactants listed above. Known anionic surfactants, amphoteric surfactants, cationic surfactants, nonionic surfactants, and the like other than the above may also be used. One surfactant may be used alone, or two or more surfactants may be used in combination.

The amount of the surfactant with respect to the resin in the molten mixture is, for example, preferably 1% by mass or more and 5% by mass or less, more preferably 1% by mass or more and 4% by mass or less, and even more preferably 1.5% by mass or more and 3.5% by mass or less.

In a case where the amount of the surfactant is in the above range, the emulsification dispersibility is improved.

### Basic Compound

Examples of the basic compound include a hydroxide of an alkali metal such as lithium, sodium, or potassium; an oxide or hydroxide of an alkaline earth metal such as magnesium or calcium; and the like. Among these, for example, a hydroxide of an alkali metal or alkaline earth metal is preferable, a hydroxide of an alkali metal is more preferable, potassium hydroxide or sodium hydroxide is even more preferable, and sodium hydroxide is particularly preferable.

The amount of the basic compound with respect to the resin in the molten mixture is, for example, preferably 5% by mass or more and 20% by mass or less, more preferably 10% by mass or more and 30% by mass or less, and even more preferably 10% by mass or more and 20% by mass or less.

In a case where the amount of the basic compound is in the above range, the emulsification dispersibility is improved.

### Aqueous Medium

Examples of the aqueous medium include water such as distilled water or deionized water; an alcohol such as ethanol or methanol; and a mixed solution thereof. Among these, for example, ethanol or water is preferable, and water such as distilled water or deionized water is particularly preferable. One of these media may be used alone, or two or more of these media may be used in combination.

The amount of the aqueous medium used is not particularly limited, and may be appropriately selected depending on the concentration of solid content of the resin particle dispersion to be obtained.

### Conditions for Emulsification Step

In the emulsification step, melting and emulsification are carried out in a range of Tm<Te<(Tm+30° C.) where Tm represents a softening temperature of the hydrophobic lubricant and Te represents an emulsification temperature.

In a case where the emulsification temperature Te is equal to or lower than the softening temperature Tm of the hydrophobic lubricant, the hydrophobic lubricant does not soften, does not coat the pigment surface, and is not interposed between the resin and the pigment, which deteriorates the dispersibility of the pigment in the resin particles. As a result, the transferability is likely to deteriorate.

On the other hand, in a case where the emulsification temperature Te is equal to or higher than (softening temperature Tm of hydrophobic lubricant+30° C.), the hydrophobic lubricant keeps softening, is finely dispersed, does not fully coat the pigment surface, and is unlikely to be interposed between the resin and the pigment. Accordingly, the exposed pigment portions are aggregated due to heat, and the dispersibility of the pigment in the resin particles deteriorates. As a result, the transferability is likely to deteriorate.

Therefore, the melting and emulsification are carried out in a range of Tm<Te<(Tm+)30° C.

The melting and emulsification are carried out, for example, preferably in a range of (Tm+5° C.)≤Te≤(Tm+25° C.), and more preferably in a range of (Tm+10° C.)≤Te≤(Tm+) 20° C.

In the emulsification step, the shearing force applied per 1 kg of the molten mixture to which the surfactant and the basic compound are added is, for example, preferably 0.03 kW·h or more and 0.10 KW·h or less, more preferably 0.05 kW·h or more and 0.09 kW·h or less, and even more preferably 0.05 kW·h or more and 0.08 kW·h or less.

In a case where the shearing force is in the above range, the chance that the hydrophobic lubricant will come into contact with the pigment while softening increases. Therefore, the hydrophobic lubricant coats the pigment surface and is interposed between the resin and the pigment, which improves the dispersibility in the resin particles. As a result, the deterioration of transferability is likely to be suppressed.

The shearing force applied per 1 kg of the molten mixture is a value calculated by the following formula.

Formula: shearing force applied per 1 kg of molten mixture=(Pe−P0)/F

In the formula, Pe represents an average motor power (kW) of an emulsification device, P0 represents an aerodynamic force (KW) of the motor of the emulsification device, and F represents an average supply amount (kg/h) of the molten mixture, to which a surfactant and a basic compound are added, to the emulsification device.

In the emulsification step, the aqueous medium may be continuously added to the molten mixture to which a surfactant and a basic compound are added, or may be sequentially added to the molten mixture two or more times.

The emulsification device for melting and emulsification in the emulsification step is not particularly limited, and examples thereof include known emulsification devices such as a kneader, a homogenizer, a homomixer, a pressure kneader, an extruder, a media disperser, and a single-screw or twin-screw extruder.

The emulsification device may be, for example, a batch type or a continuous type, and is preferably a continuous-type twin-screw extruder.

Through the above steps, a resin particle dispersion is obtained.

The concentration of solid content of the resin particle dispersion to be obtained may be appropriately selected as necessary, and is, for example, preferably 1% by mass or more and 60% by mass or less, more preferably 5% by mass or more and 50% by mass or less, and even more preferably 10% by mass or more and 50% by mass or less.

The manufacturing method of a resin particle dispersion according to the present exemplary embodiment may include other steps in addition to the melting step and the emulsification step.

As the other steps, known steps can be performed as necessary without particular limitation. For example, a step of cooling the obtained resin particle dispersion and the like may be performed.

### Manufacturing Method of Toner/Toner

The manufacturing method of a toner according to the present exemplary embodiment has
a step of aggregating at least the resin particles in a dispersion containing the resin particles of the resin particle dispersion obtained by the manufacturing method of a resin particle dispersion according to the present exemplary embodiment to form aggregated particles (hereinafter, called an aggregated particle-forming step), and
a step of coalescing the aggregated particles by heating an aggregated particle dispersion containing the aggregated particles dispersed to form toner particles (hereinafter, called an aggregation and coalescence step).

The toner according to the present exemplary embodiment is a toner having toner particles obtained by the manufacturing method of a toner according to the present exemplary embodiment.

Hereinafter, each of the steps will be specifically described.

In the following section, a method for obtaining toner particles containing a colorant and a release agent will be described. The colorant and the release agent are used as necessary. It goes without saying that other additives different from the colorant and the release agent may also be used.

### Particle Dispersion-Preparing Step

In the particle dispersion-preparing step, a colorant particle dispersion and a release agent dispersion are prepared together with a resin particle dispersion.

### Resin Particle Dispersion

The resin particle dispersion is manufactured according to the manufacturing method of a resin particle dispersion according to the present exemplary embodiment described above.

Here, a resin particle dispersion (hereinafter, also called “another resin particle dispersion”) other than the resin particle dispersion obtained by the manufacturing method of a resin particle dispersion according to the present exemplary embodiment may be used together.

Hereinafter, the another resin particle dispersion will be described.

The another resin particle dispersion is, for example, a dispersion prepared by dispersing resin particles in at least an aqueous medium. The another resin particle dispersion may contain a surfactant.

The resin is, for example, a resin that functions as a binder resin for a toner, and examples thereof include the resins exemplified above regarding the resin particle dispersion according to the present exemplary embodiment.

Particularly, from the viewpoint of using the resin as a binder resin for a toner, the resin is, for example, preferably a polyester resin. As the resin, the same resin as the resin used in the resin particle dispersion according to the present exemplary embodiment may be used.

Examples of the aqueous medium include distilled water, water such as deionized water, alcohols, and the like. One of these media may be used alone, or two or more of these media may be used in combination.

Examples of the surfactant include the surfactants exemplified above regarding the resin particle dispersion according to the present exemplary embodiment. One surfactant may be used alone, or two or more surfactants may be used in combination.

As for the another resin particle dispersion, examples of the method for dispersing resin particles in the dispersion medium include general dispersion methods such as a rotary shearing homogenizer, a ball mill having media, a sand mill, and a dyno mill. Depending on the type of resin particles, the resin particles may be dispersed in the dispersion medium by using a transitional phase inversion emulsification method. The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes phase transition from W/O to O/W and is dispersed in the aqueous medium in the form of particles.

The volume-average particle size of the resin particles dispersed in the another resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the another resin particle dispersion is, for example, preferably 5% by mass or more and 50% by mass or less, and more preferably 10% by mass or more and 40% by mass or less.

### Colorant Particle Dispersion

The resin particle dispersion obtained by the manufacturing method of a resin particle dispersion according to the present exemplary embodiment contains a pigment having an isoindoline skeleton. As necessary, a colorant particle dispersion may be additionally used.

The colorant particle dispersion is a dispersion obtained by dispersing a colorant in at least an aqueous medium.

Examples of colorants include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

One colorant may be used alone, or two or more colorants may be used in combination.

The colorant is dispersed in an aqueous medium by a known method. For example, a rotary shearing homogenizer, a media-type disperser such as a ball mill, a sand mill, or an attritor, a high-pressure collision type disperser, and the like are preferably used. Furthermore, the colorant may be dispersed in an aqueous medium with a homogenizer by using an ionic surfactant having polarity to prepare the colorant particle dispersion.

Examples of the surfactant include the surfactants exemplified above regarding the resin particle dispersion according to the present exemplary embodiment. One surfactant may be used alone, or two or more surfactants may be used in combination.

The volume-average particle size of the colorant is, for example, preferably 1 μm or less, more preferably 0.5 μm or less, and particularly preferably 0.01 μm or more and 0.5 μm or less.

Examples of dispersants that are added to further improve the dispersion stability of the colorant in an aqueous medium and reduce the energy of the colorant in the toner include rosin, a rosin derivative, a coupling agent, a polymer dispersant, and the like.

### Release Agent Particle Dispersion

The release agent particle dispersion is a dispersion obtained by dispersing a release agent in at least an aqueous medium.

Examples of the release agent include hydrocarbon-based wax; natural wax such as carnauba wax, rice wax, and candelilla wax; synthetic or mineral petroleum-based wax such as montan wax; ester-based wax such as fatty acid esters and montanic acid esters; and the like. The release agent is not limited to these.

One release agent may be used alone, or two or more release agents may be used in combination.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The release agent is dispersed in an aqueous medium by a known method. For example, a rotary shearing homogenizer, a media-type disperser such as a ball mill, a sand mill, or an attritor, a high-pressure collision type disperser, and the like are preferably used. Furthermore, the release agent may be dispersed in an aqueous solvent with a homogenizer by using an ionic surfactant having polarity to prepare the release agent particle dispersion.

Examples of the surfactant include the surfactants exemplified above regarding the resin particle dispersion according to the present exemplary embodiment. One surfactant may be used alone, or two or more surfactants may be used in combination.

The volume-average particle size of the release agent particles is, for example, preferably 1 μm or less, and more preferably 0.01 μm or more and 1 μm or less.

### Aggregated Particle-Forming Step

Next, the resin particle dispersion is mixed with the colorant particle dispersion and the release agent particle dispersion.

Then, in the mixed dispersion, the resin particles, the colorant particles, and the release agent particles are hetero-aggregated such that aggregated particles are formed which have a diameter close to the diameter of the target toner particles and include the resin particles, the colorant particles, and the release agent particles.

Specifically, for example, an aggregating agent is added to the mixed dispersion, the pH of the mixed dispersion is adjusted such that the dispersion is acidic (for example, pH of 2 or higher and 5 or lower), and a dispersion stabilizer is added thereto as necessary. Then, the dispersion is heated to the glass transition temperature of the resin particles (specifically, for example, to a temperature equal to or higher than the glass transition temperature of the resin particles −30° C. and equal to or lower than the glass transition temperature of the resin particles −10° C.) such that the particles dispersed in the mixed dispersion are aggregated, thereby forming aggregated particles.

In the aggregated particle-forming step, for example, in a state where the mixed dispersion is being stirred with a rotary shearing homogenizer, an aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. Particularly, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; inorganic metal salt polymers such as polyaluminum chloride, polyaluminum hydroxide, and calcium polysulfide; and the like.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA), and the like.

The amount of the chelating agent added with respect to 100 parts by mass of resin particles is, for example, preferably 0.01 parts by mass or more and 5.0 parts by mass or less, and more preferably 0.1 parts by mass or more and less than 3.0 parts by mass.

### Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed to cause the resin particles to be aggregated and adhere to the surface of the aggregated particles and to form second aggregated particles, and a step of heating a second aggregated particle dispersion in which the second aggregated particles are dispersed to cause the second aggregated particles to coalesce and to form toner particles having a core/shell structure.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

Then, for example, by adding an external additive to the obtained dry toner particles and mixing together the external additive and the toner particles, the toner according to the present exemplary embodiment is manufactured and the manufacturing method thereof is performed. The mixing may be performed, for example, using a V blender, a Henschel mixer, a Lodige mixer, or the like. Furthermore, coarse particles of the toner may be removed as necessary by using a vibratory sieving machine, a pneumatic sieving machine, or the like.

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, NazO, ZrO₂, CaO·SiO₂, K₂O·(TiO₂)n, Al₂O₃·2SiO₂, CaCO₃, MgCO₃, BaSO₄, MgSO₄, and the like.

The surface of the inorganic particles as an external additive may have undergone, for example, a hydrophobic treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, an aluminum-based coupling agent, and the like. Each of these agents may be used alone, or two or more of these agents may be used in combination.

Usually, the amount of the hydrophobic agent is, for example, 1 part by mass or more and 10 parts by mass or less with respect to 100 parts by mass of the inorganic particles.

Examples of external additives also include resin particles (resin particles such as polystyrene, polymethylmethacrylate (PMMA), and melamine resins), a cleaning activator (for example, a metal salt of a higher fatty acid represented by zinc stearate or fluorine-based polymer particles), and the like.

The amount of the external additives added to the exterior of the toner particles with respect to the toner particles is, for example, preferably 0.01% by mass or more and 10% by mass or less, and more preferably 1% by mass or more and 6% by mass or less.

### Characteristics of Toner

In the toner according to the present exemplary embodiment, the toner particles may be toner particles that have a single-layer structure or toner particles having a so-called core/shell structure that is configured with a core portion (core particle) and a coating layer (shell layer) covering the core portion.

The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter Inc.) and using ISOTON-II (manufactured by Beckman Coulter Inc.) as an electrolytic solution.

For measurement, a measurement sample in an amount of 0.5 mg or more and 50 mg or less is added to 2 ml of a 5% aqueous solution of a surfactant (preferably sodium alkylbenzene sulfonate, for example) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (circular equivalent perimeter)/(perimeter) [(perimeter of circle having the same projected area as particle image)/(perimeter of projected particle image)]. Specifically, the average circularity is a value measured by the following method.

First, toner particles as a measurement target are collected by suction, and a flat flow of the particles is formed. Then, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains external additives, the toner (developer) as a measurement target is dispersed in water containing a surfactant, then the dispersion is treated with ultrasonic waves such that the external additives are removed, and the toner particles are collected.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer which contains only the toner according to the present exemplary embodiment or a two-component developer which is obtained by mixing together the toner and a carrier.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; a resin impregnation-type carrier obtained by impregnating porous magnetic powder with a resin; and the like.

Each of the magnetic powder dispersion-type carrier and the resin impregnation-type carrier may be a carrier obtained by coating a core material, which is particles configuring the carrier, with a coating resin.

### EXAMPLES

Examples of the present invention will be described below, but the present invention is not limited to the following examples. In the following description, unless otherwise specified, “parts” and “%” are based on mass in all cases.

### Example 1

Preparation of Polyester Resin (P1)
Terephthalic acid: 70 parts
Fumaric acid: 30 parts
Ethylene glycol: 30 parts
1,5-Pentanediol: 40 parts

The above materials are put in a flask with an inner capacity of 5 L equipped with a stirrer, a nitrogen introduction tube, a temperature sensor, and a rectifying column, the temperature is raised to 220° C. for an hour under a nitrogen gas stream, and titanium tetraethoxide is added thereto in an amount of 1 part with respect to 100 parts of the above materials. While the generated water is being distilled off, the temperature is raised to 240° C. for 0.5 hours, a dehydration condensation reaction is continued for 1 hour at 240° C., and then the reactant is cooled. In this way, a polyester resin having an acid value of 15.0 mgKOH/g and a softening temperature of 59° C. is synthesized.

### Preparation of Polyester Resin Particle Dispersion (A1)

### Melt Mixing Step

A polyester resin (P1) (150 parts) as a resin, 50 parts of C. I. Pigment Yellow 185 (PY185, manufactured by BASF SE) as a pigment having an isoindoline skeleton, and 15 parts of erucic acid amide (manufactured by Nippon Fine Chemical, softening temperature 80° C.) as a hydrophobic lubricant are put into a Henschel mixer and mixed together at a screw rotation speed of 600 rpm for 120 seconds, thereby obtaining a resin mixture.

Then, the obtained resin mixture is put into a raw material input port of a twin-screw extruder (TEM-58SS, manufactured by Toshiba Machine Co., Ltd.), melted and mixed at a barrel temperature of 110° C. and a screw rotation speed of 600 rpm, and pulverized, thereby obtaining a molten mixture (A).

### Emulsification Step

The molten mixture (A) (200 parts) and 20 parts of a 50% aqueous sodium hydroxide solution as a basic compound are put into a raw material input port of a twin-screw extruder (TEM-58SS, manufactured by Toshiba Machine Co., Ltd.), 5.0 parts of a 48.5% aqueous solution of sodium dodecyl diphenyl ether sulfonate (ELEMINOL MON-7, manufactured by Sanyo Chemical Industries, Ltd.) as a surfactant is added at the 4th barrel of the twin-screw extruder, and the mixture is kneaded at a set temperature (that is, an emulsification temperature) of each barrel of 90° C. and a screw rotation speed of 400 rpm.

Deionized water (150 parts) is added at the 5th barrel of the twin-screw extruder, 150 parts by mass of deionized water is added at the 7th barrel, 15 parts of deionized water is added at the 9th barrel, and the mixture is kneaded at an average supply amount of the molten mixture (A) of 200 kg/h, thereby obtaining a resin particle dispersion in which resin particles having a volume-average particle size of 180 nm are dispersed.

In the emulsification step, a shearing force applied per 1 kg of the molten mixture to which a surfactant and the aforementioned basic compound are added is 0.06 kW·h.

Then, deionized water is added to the obtained resin particle dispersion to adjust the solid content to 20%, thereby obtaining a polyester resin particle dispersion (A1) containing C. I. Pigment Yellow 185.

### Preparation of Polyester Resin Dispersion (A2)

Ethyl acetate (40 parts) and 25 parts of 2-butanol are put in a container equipped with a temperature control unit and a nitrogen purge unit, thereby preparing a mixed solvent. Then, 100 parts of the amorphous polyester resin (P1) is slowly added to and dissolved in the solvent, a 10% aqueous ammonia solution (in an amount equivalent to 3 times the acid value of the resin in terms of molar ratio) is added thereto, and the mixed solution is stirred for 30 minutes. Thereafter, the container is cleaned out by dry nitrogen purging, and in a state where the mixed solution is being stirred at a temperature kept at 40° ° C., 400 parts of deionized water is added dropwise thereto at a rate of 2 parts/min such that the mixed solution is emulsified. After dropwise addition ends, the emulsion is returned to 25° C., thereby obtaining a resin particle dispersion in which resin particles having a volume-average particle size of 200 nm are dispersed. Deionized water is added to the resin particle dispersion, and the solid content thereof is adjusted to 20%, thereby obtaining a polyester resin particle dispersion (A2).

### Preparation of Release Agent Particle Dispersion

Paraffin wax (manufactured by NIPPON SEIRO CO., LTD., HNP-9,): 100 parts
Anionic surfactant (manufactured by DKS Co. Ltd., NEOGEN RK): 1 part
Deionized water: 350 parts

The above materials are mixed together, heated to 100° C., and dispersed using a homogenizer (ULTRA-TURRAX T50 manufactured by IKA). Then, by using Manton Gaulin high-pressure homogenizer (manufactured by Gaulin Corporation), dispersion treatment is performed, thereby obtaining a release agent particle dispersion (solid content of 20%) in which release agent particles having a volume-average particle size of 200 nm are dispersed.

### Preparation of Toner

Deionized water: 200 parts
Polyester resin particle dispersion (A1): 200 parts
Release agent dispersion: 20 parts
Anionic surfactant (TaycaPower): 2.8 parts
Tetrakistrimethylsiloxysilane 0.5 parts by mass (manufactured by Tokyo Chemical Industry Co., Ltd., T3494)

The above materials are put in a round flask made of stainless steel, 0.1N nitric acid is added thereto to adjust the pH to 3.5, and then an aqueous PAC solution obtained by dissolving 2.0 parts of PAC (manufactured by Oji Paper Co., Ltd., 30% powder product) in 30 parts of deionized water is added thereto. The obtained solution is dispersed at 30° C. by using a homogenizer (ULTRA-TURRAX T50 manufactured by IKA), then heated to 45° C. in an oil bath for heating, and kept as it is until the volume-average particle size reaches 4.8 μm. Then, 60 parts of the resin particle dispersion liquid (A1) is added thereto, and the mixture is kept as it is for 30 minutes. Thereafter, at a point in time when the particle size has reached 5.2 μm, 60 parts of the resin particle dispersion (A2) is further added thereto, and the mixture is kept as it is for 30 minutes. Subsequently, 20 parts of a 10% by mass aqueous solution of NTA (nitrilotriacetic acid) metal salt (CHELEST 70, manufactured by Chelest Corporation) is added thereto, and then a 1N aqueous sodium hydroxide solution is used to adjust the pH to 9.0. Next, 1.0 part of an anionic activator (TaycaPower) is added thereto, and the mixture is heated to 85° C. while being continuously stirred and kept as it is for 5 hours. Then, the mixture is cooled to 60° C. at a rate of 20° C./min and kept as it is for 30 minutes. Thereafter, the mixture is cooled to 20° C. at a rate of 10° C./min, filtered, thoroughly washed with deionized water, and dried, thereby obtaining toner particles (1) having a volume-average particle size of 6.0 μm.

Hydrophobic silica (3 parts by mass, RY50 manufactured by Nippon Aerosil Co., Ltd.) and 100 parts by mass of the obtained toner particles are blended at 10,000 rpm for 30 seconds by using a sample mill. Then, the toner particles are sieved with a vibration sieve having an opening size of 45 μm, thereby preparing a toner (1). The volume-average particle size of the obtained toner (1) is 6.0 μm.

### Preparation of Developer

The obtained toner (1) and a carrier are put in a V blender at a ratio of toner:carrier=5:95 (mass ratio) and stirred for 20 minutes, thereby obtaining a developer (1).

The used carrier is prepared as below.
Ferrite particles (volume-average particle size: 35 μm): 100 parts
Toluene: 14 parts
Styrene-methyl methacrylate copolymer: 2 parts

(Component ratio: 90/10, Mw=80,000)
Carbon black (R330: manufactured by Cabot Corporation): 0.2 parts

First, the above components excluding the ferrite particles are stirred with a stirrer for 10 minutes, thereby preparing a dispersed coating liquid. Thereafter, the coating liquid and the ferrite particles are put in a vacuum deaerating kneader, stirred at 60° ° C. for 30 minutes, and then deaerated under reduced pressure while being heated, followed by drying, thereby obtaining a carrier.

### Comparative Example 1

### Preparation of Yellow Colored Particle Dispersion

C. I. Pigment Yellow 185 (PY185, BASF SE): 50 parts
Ionic surfactant NEOGEN RK (manufactured by DKS Co. Ltd.): 5 parts
Deionized water: 192.9 parts

The above components are mixed together and treated with ULTIMAIZER (manufactured by SUGINO MACHINE LIMITED) at 240 MPa for 10 minutes, thereby preparing a yellow colored particle dispersion (concentration of solid content: 20%).

### Preparation of Developer

Toner particles (2) having a volume-average particle size of 6.2 μm are obtained in the same manner as the toner particles (1) of Example 1, except that 125.4 parts of the polyester resin dispersion (A2) and 45.4 parts of the yellow colored particle dispersion are added instead of the polyester resin dispersion (A1).

A toner (2) and a developer (2) are obtained in the same manner as the toner (1) and the developer (1) of Example 1, except that the toner particles (2) are used instead of the toner (1).

### Example 2

Toner particles (3) having a volume-average particle size of 6.1 μm are obtained in the same manner as the toner particles (1) of Example 1, except that 75 parts of C. I. Pigment Yellow 139 are added instead of C. I. Pigment Yellow 185 at the time of preparing the polyester resin particle dispersion (A1), and 133 parts of the polyester resin particle dispersion (A1) and 67 parts of the polyester resin dispersion (A2) are added at the time of preparing toner particles.

By using the toner particles (3), a toner and a developer are obtained in the same manner as in Example 1.

### Example 3

Toner particles (4) having a volume-average particle size of 6.2 μm are obtained in the same manner as the toner particles (1) of Example 1, except that the barrel temperature (that is, the emulsification temperature) is set to 104° C. at the time of preparing the polyester resin particle dispersion (A1).

By using the toner particles (4), a toner and a developer are obtained in the same manner as in Example 1.

### Example 4

Toner particles (5) having a volume-average particle size of 6.0 μm are obtained in the same manner as the toner particles (1) of Example 1, except that the barrel temperature (that is, the emulsification temperature) is set to 76° C. at the time of preparing the polyester resin particle dispersion (A1).

By using the toner particles (5), a toner and a developer are obtained in the same manner as in Example 1.

### Example 5

Toner particles (6) having a volume-average particle size of 6.3 μm are obtained in the same manner as the toner particles (1) of Example 1, except that stearic acid amide is added instead of erucic acid amide and the barrel temperature (that is, the emulsification temperature) is set to 110° C. at the time of preparing the polyester resin particle dispersion (A1).

By using the toner particles (6), a toner and a developer are obtained in the same manner as in Example 1.

### Example 6

In preparing the polyester resin (P1), the following materials are used to synthesize a polyester resin (P2) having an acid value of 16.0 mgKOH/g and a softening temperature of 50° C.

Materials of Polyester Resin (P2)
Terephthalic acid: 60 parts
Fumaric acid: 40 parts
Ethylene glycol: 30 parts
1,5-Pentanediol: 40 parts

Toner particles (7) having a volume-average particle size of 6.4 μm are obtained in the same manner as the toner particles (1) of Example 1, except that the polyester resin (P2) and glycerin stearate are added to the polyester resin particle dispersion (A1) instead of the polyester resin (P1) and erucic acid amide respectively, and the barrel temperature (that is, the emulsification temperature) is set to 80° C.

By using the toner particles (7), a toner and a developer are obtained in the same manner as in Example 1.

### Example 7

Toner particles (8) having a volume-average particle size of 6.0 μm are obtained in the same manner as the toner particles (1) of Example 1, except that magnesium stearate is added instead of erucic acid amide and the barrel temperature (that is, the emulsification temperature) is set to 120° C. at the time of preparing the polyester resin particle dispersion (A1).

By using the toner particles (8), a toner and a developer are obtained in the same manner as in Example 1.

### Example 8

Toner particles (9) having a volume-average particle size of 6.0 μm are obtained in the same manner as the toner particles (7) of Example 6, except that stearyl stearate is added instead of glycerin stearate at the time of preparing the polyester resin particle dispersion (A1).

By using the toner particles (9), a toner and a developer are obtained in the same manner as in Example 1.

### Example 9

Toner particles (10) having a volume-average particle size of 6.1 μm are obtained in the same manner as the toner particles (7) of Example 6, except that stearic acid amide is added instead of glycerin stearate and the barrel temperature (that is, the emulsification temperature) is set to 70° C. at the time of preparing the polyester resin particle dispersion (A1).

By using the toner particles (10), a toner and a developer are obtained in the same manner as in Example 1.

### Example 10

Toner particles (11) having a volume-average particle size of 6.2 μm are obtained in the same manner as the toner particles (7) of Example 6, except that the barrel temperature (that is, the emulsification temperature) is set to 90° C. at the time of preparing the polyester resin particle dispersion (A1).

By using the toner particles (11), a toner and a developer are obtained in the same manner as in Example 1.

### Example 11

In preparing the polyester resin (P1), the following materials are used to synthesize a polyester resin (P3) having an acid value of 17.0 mgKOH/g and a softening temperature of 47° C.

### Materials of Polyester Resin (P3)

Terephthalic acid: 50 parts
Fumaric acid: 50 parts
Ethylene glycol: 30 parts
1,5-Pentanediol: 40 parts

Toner particles (12) having a volume-average particle size of 6.4 μm are obtained in the same manner as the toner particles (6) of Example 5, except that the polyester resin (P3) is used in the polyester resin particle dispersion (A1) instead of the polyester resin (P1).

By using the toner particles (12), a toner and a developer are obtained in the same manner as in Example 1.

### Example 12

In preparing the polyester resin (P1), the following materials are used to synthesize a polyester resin (P4) having an acid value of 12.0 mgKOH/g and a softening temperature of 64° C.

### Materials of Polyester Resin (P4)

Terephthalic acid: 90 parts
Fumaric acid: 10 parts
Ethylene glycol: 30 parts
1,5-Pentanediol: 40 parts

Toner particles (13) having a volume-average particle size of 6.4 μm are obtained in the same manner as the toner particles (11) of Example 10, except that the polyester resin (P4) is used instead of the polyester resin (P1) at the time of preparing the polyester resin particle dispersion (A1).

By using the toner particles (13), a toner and a developer are obtained in the same manner as in Example 1.

### Example 13

Toner particles (14) having a volume-average particle size of 6.0 μm are obtained in the same manner as the toner particles (6) of Example 5, except that triacontanoic acid is used instead of stearic acid amide at the time of preparing the polyester resin particle dispersion (A1).

By using the toner particles (14), a toner and a developer are obtained in the same manner as in Example 1.

### Example 14

Toner particles (15) having a volume-average particle size of 6.1 μm are obtained in the same manner as the toner particles (6) of Example 5, except that lauric acid amide is used instead of stearic acid amide at the time of preparing the polyester resin particle dispersion (A1).

By using the toner particles (15), a toner and a developer are obtained in the same manner as in Example 1.

### Example 15

Toner particles (16) having a volume-average particle size of 6.2 μm are obtained in the same manner as the toner particles (6) of Example 5, except that dotriacontanoic acid is used instead of stearic acid amide at the time of preparing the polyester resin particle dispersion (A1).

By using the toner particles (16), a toner and a developer are obtained in the same manner as in Example 1.

### Example 16

Toner particles (17) having a volume-average particle size of 6.0 μm are obtained in the same manner as the toner particles (6) of Example 5, except that octanoic acid amide is used instead of stearic acid amide at the time of preparing the polyester resin particle dispersion (A1).

By using the toner particles (17), a toner and a developer are obtained in the same manner as in Example 1.

### Example 17

In preparing the polyester resin (P1), the following materials are used to synthesize a polyester resin (P5) having an acid value of 8.0 mgKOH/g and a softening temperature of 65° C.

### Materials of Polyester Resin (P5)

Terephthalic acid: 90 parts
Fumaric acid: 10 parts
Ethylene glycol: 10 parts
1,5-Pentanediol: 60 parts

Toner particles (18) having a volume-average particle size of 6.2 μm are obtained in the same manner as the toner particles (1) of Example 1, except that the polyester resin (P5) is used instead of the polyester resin (P1) at the time of preparing the polyester resin particle dispersion (A1).

By using the toner particles (18), a toner and a developer are obtained in the same manner as in Example 1.

### Example 18

In preparing the polyester resin (P1), the following materials are used to synthesize a polyester resin (P6) having an acid value of 11.0 mgKOH/g and a softening temperature of 63° C.

### Materials of Polyester Resin (P6)

Terephthalic acid: 80 parts
Fumaric acid: 20 parts
Ethylene glycol: 20 parts
1,5-Pentanediol: 50 parts

Toner particles (19) having a volume-average particle size of 6.2 μm are obtained in the same manner as the toner particles (1) of Example 1, except that the polyester resin (P6) is used instead of the polyester resin (P1) at the time of preparing the polyester resin particle dispersion (A1).

By using the toner particles (19), a toner and a developer are obtained in the same manner as in Example 1.

### Example 19

In preparing the polyester resin (P1), the following materials are used to synthesize a polyester resin (P7) having an acid value of 30.0 mgKOH/g and a softening temperature of 60° C.

### Materials of Polyester Resin (P7)

Terephthalic acid: 20 parts
Fumaric acid: 30 parts
Trimellitic anhydride: 50 parts
Ethylene glycol: 30 parts
1,4-Hexanediol: 40 parts

Toner particles (20) having a volume-average particle size of 6.1 μm are obtained in the same manner as the toner particles (1) of Example 1, except that the polyester resin (P7) is used instead of the polyester resin (P1) at the time of preparing the polyester resin particle dispersion (A1).

By using the toner particles (20), a toner and a developer are obtained in the same manner as in Example 1.

### Example 20

In preparing the polyester resin (P1), the following materials are used to synthesize a polyester resin (P8) having an acid value of 45.0 mgKOH/g and a softening temperature of 55° C.

### Materials of Polyester Resin (P8)

Fumaric acid: 30 parts
Trimellitic anhydride: 70 parts
Ethylene glycol: 20 parts
1,4-Hexanediol: 50 parts

Toner particles (21) having a volume-average particle size of 6.3 μm are obtained in the same manner as the toner particles (1) of Example 1, except that the polyester resin (P8) is used instead of the polyester resin (P1) at the time of preparing the polyester resin particle dispersion (A1).

By using the toner particles (21), a toner and a developer are obtained in the same manner as in Example 1.

### Example 21

Toner particles (22) having a volume-average particle size of 6.1 μm are obtained in the same manner as the toner particles (1) of Example 1, except that the amount of erucic acid amide added is changed to 25 parts at the time of preparing the polyester resin particle dispersion (A1).

By using the toner particles (22), a toner and a developer are obtained in the same manner as in Example 1.

### Example 22

Toner particles (23) having a volume-average particle size of 6.0 μm are obtained in the same manner as the toner particles (1) of Example 1, except that the amount of erucic acid amide added is changed to 5 parts at the time of preparing the polyester resin particle dispersion (A1).

By using the toner particles (23), a toner and a developer are obtained in the same manner as in Example 1.

### Example 23

Toner particles (24) having a volume-average particle size of 6.1 μm are obtained in the same manner as the toner particles (1) of Example 1, except that the amount of erucic acid amide added is changed to 30 parts at the time of preparing the polyester resin particle dispersion (A1).

By using the toner particles (24), a toner and a developer are obtained in the same manner as in Example 1.

### Example 24

Toner particles (25) having a volume-average particle size of 6.2 μm are obtained in the same manner as the toner particles (1) of Example 1, except that the amount of erucic acid amide added is changed to 3 parts at the time of preparing the polyester resin particle dispersion (A1).

By using the toner particles (25), a toner and a developer are obtained in the same manner as in Example 1.

### Example 25

Toner particles (26) having a volume-average particle size of 6.2 μm are obtained in the same as the toner particles (1) of Example 1, except that the screw rotation speed during emulsification is set to 700 rpm at the time of preparing the polyester resin particle dispersion (A1).

By using the toner particles (26), a toner and a developer are obtained in the same manner as in Example 1.

### Example 26

Toner particles (27) having a volume-average particle size of 6.1 μm are obtained in the same as the toner particles (1) of Example 1, except that the screw rotation speed during emulsification is set to 200 rpm at the time of preparing the polyester resin particle dispersion (A1).

By using the toner particles (27), a toner and a developer are obtained in the same manner as in Example 1.

### Example 27

Toner particles (28) having a volume-average particle size of 6.2 μm are obtained in the same as the toner particles (1) of Example 1, except that the screw rotation speed during emulsification is set to 800 rpm at the time of preparing the polyester resin particle dispersion (A1).

By using the toner particles (28), a toner and a developer are obtained in the same manner as in Example 1.

### Example 28

Toner particles (29) having a volume-average particle size of 6.1 μm are obtained in the same manner as the toner particles (1) of Example 1, except that the screw rotation speed during emulsification is set to 150 rpm at the time of preparing the polyester resin particle dispersion (A1).

By using the toner particles (29), a toner and a developer are obtained in the same manner as in Example 1.

### Comparative Example 2

Toner particles (30) having a volume-average particle size of 6.1 μm are obtained in the same manner as the toner particles (1) of Example 1, except that the barrel temperature (that is, the emulsification temperature) is set to 70° ° C. at the time of preparing the polyester resin particle dispersion (A1).

By using the toner particles (30), a toner and a developer are obtained in the same manner as in Example 1.

### Comparative Example 3

Toner particles (31) having a volume-average particle size of 6.3 μm are obtained in the same manner as the toner particles (1) of Example 1, except that the barrel temperature (that is, the emulsification temperature) is set to 120° ° C. at the time of preparing the polyester resin particle dispersion (A1).

By using the toner particles (31), a toner and a developer are obtained in the same manner as in Example 1.

### Evaluation

The developer of each example is stored in the developing machine of an image forming apparatus (“modified Apeosport 6-C7771” manufactured by FUJIFILM Business Innovation Corp.).

The following evaluation is performed using the image forming apparatus.

### Evaluation of Transferability at High Temperature and High Humidity

In an environment at a temperature of 28° C. and a humidity of 85%, an image sample with a rectangular patche (5 cm×5 cm) drawn thereon is printed on 10,000 sheets at an image density of 1%. Thereafter, a solid image having an image density of 100% is printed on one sheet of embossed paper (REZAKKU 66 manufactured by Tokushu Tokai Paper Co., Ltd., 203 gsm), and then the image quality is evaluated (whether or not color omission occurs is checked). In a case where the obtained image is visually checked, the transferability thereof is graded based on the following criteria. As for the evaluation, the grade up to G3 is regarded as an acceptable range. The results are shown in Table 1.

### Evaluation Criteria for Transferability

G1: There is no color omission in the image.
G2: There are 1 or more and 3 or less color omission sites in the image.
G2.5: There are 4 or more and 5 or less color omission sites in the image.
G3: There are 6 or more and 10 or less color omission sites in the image.
G4: There are 11 or more and 15 or less color omission sites in the image.
G5: There are 16 or more color omission sites in the image.

TABLE 1

| | | | Hydrophobic lubricant | | | | | | | | | | |
|---|---|---|---|---|---|---|---|---|---|---|---|---|---|
| | | | Type | | | | | | | | | | |
| | | | | Number | | | | | | | | | |
| | | | | of | | Amount | | Acid value of | | | | | |
| | | | | carbon | | (with | Soft- | polyester | | Emulsi- | | | |
| | | | | atoms | | respect | ening | | Soft- | fication | | | |
| | | | | of | | to pig- | temper- | | ening | temper- | | | |
| | Pigment | | | hydro- | | ment) | ature | Acid | temper- | ature | Tm + | Shearing | Trans- |
| | Type | Amount | Compound | carbon | Amount | % by | Tm | value | ature | Te | 30 | force | fer- |
| | — | Parts | name | chain | Parts | mass | ° C. | mgKOH | ° C. | ° C. | ° C. | kW · h/kg | ability |
| Example 1 | PY185 | 50 | Erucic acid | 21 | 15 | 30 | 75 | 15 | 59 | 90 | 105 | 0.06 | G1 |
| | | | amide | | | | | | | | | | |
| Example 2 | PY139 | 75 | Erucic acid | 21 | 15 | 20 | 75 | 15 | 59 | 90 | 105 | 0.06 | G1 |
| | | | amide | | | | | | | | | | |
| Example 3 | PY185 | 50 | Erucic acid | 21 | 15 | 30 | 75 | 15 | 59 | 104 | 105 | 0.06 | G3 |
| | | | amide | | | | | | | | | | |
| Example 4 | PY185 | 50 | Erucic acid | 21 | 15 | 30 | 75 | 15 | 59 | 76 | 105 | 0.06 | G3 |
| | | | amide | | | | | | | | | | |
| Example 5 | PY185 | 50 | Stearic acid | 17 | 15 | 30 | 98 | 15 | 59 | 110 | 128 | 0.07 | G2 |
| | | | amide | | | | | | | | | | |
| Example 6 | PY185 | 50 | Glycerin | 17 | 15 | 30 | 64 | 16 | 50 | 80 | 94 | 0.06 | G2 |
| | | | monostearate | | | | | | | | | | |
| Example 7 | PY185 | 50 | Magnesium | 17 | 15 | 30 | 105 | 15 | 59 | 120 | 135 | 0.08 | G2.5 |
| | | | stearate | | | | | | | | | | |
| Example 8 | PY185 | 50 | Stearyl stearate | 17 | 15 | 30 | 59 | 16 | 50 | 80 | 89 | 0.06 | G2.5 |
| Example 9 | PY185 | 50 | Stearic acid | 17 | 15 | 30 | 98 | 16 | 50 | 70 | 128 | 0.06 | G2 |
| | | | amide | | | | | | | | | | |
| Example 10 | PY185 | 50 | Glycerin | 17 | 15 | 30 | 64 | 15 | 59 | 90 | 94 | 0.06 | G2 |
| | | | monostearate | | | | | | | | | | |
| Example 11 | PY185 | 50 | Stearic acid | 17 | 15 | 30 | 98 | 17 | 47 | 110 | 128 | 0.06 | G2.5 |
| | | | amide | | | | | | | | | | |
| Example 12 | PY185 | 50 | Glycerin | 17 | 15 | 30 | 64 | 12 | 64 | 90 | 94 | 0.06 | G2.5 |
| | | | monostearate | | | | | | | | | | |
| Example 13 | PY185 | 50 | Triacontanoic | 30 | 15 | 30 | 91 | 15 | 59 | 110 | 121 | 0.07 | G1 |
| | | | acid | | | | | | | | | | |
| Example 14 | PY185 | 50 | Lauric acid | 11 | 15 | 30 | 97 | 15 | 59 | 110 | 127 | 0.07 | G2 |
| | | | amide | | | | | | | | | | |
| Example 15 | PY185 | 50 | Dotriacontanoic | 32 | 15 | 30 | 95 | 15 | 59 | 110 | 125 | 0.07 | G2.5 |
| | | | acid | | | | | | | | | | |
| Example 16 | PY185 | 50 | Octanoic acid | 7 | 15 | 30 | 99 | 15 | 59 | 110 | 129 | 0.08 | G2.5 |
| | | | amide | | | | | | | | | | |
| Example 17 | PY185 | 50 | Erucic acid | 21 | 15 | 30 | 75 | 8 | 65 | 90 | 105 | 0.05 | G2.5 |
| | | | amide | | | | | | | | | | |
| Example 18 | PY185 | 50 | Erucic acid | 21 | 15 | 30 | 75 | 11 | 63 | 90 | 105 | 0.06 | G2 |
| | | | amide | | | | | | | | | | |
| Example 19 | PY185 | 50 | Erucic acid | 21 | 15 | 30 | 75 | 30 | 60 | 90 | 105 | 0.06 | G2 |
| | | | amide | | | | | | | | | | |
| Example 20 | PY185 | 50 | Erucic acid | 21 | 15 | 30 | 75 | 45 | 55 | 90 | 105 | 0.06 | G2.5 |
| | | | amide | | | | | | | | | | |
| Example 21 | PY185 | 50 | Erucic acid | 21 | 25 | 50 | 75 | 15 | 59 | 90 | 105 | 0.06 | G2 |
| | | | amide | | | | | | | | | | |
| Example 22 | PY185 | 50 | Erucic acid | 21 | 5 | 10 | 75 | 15 | 59 | 90 | 105 | 0.06 | G1 |
| | | | amide | | | | | | | | | | |
| Example 23 | PY185 | 50 | Erucic acid | 21 | 30 | 60 | 75 | 15 | 59 | 90 | 105 | 0.06 | G2.5 |
| | | | amide | | | | | | | | | | |
| Example 24 | PY185 | 50 | Erucic acid | 21 | 3 | 6 | 75 | 15 | 59 | 90 | 105 | 0.06 | G2.5 |
| | | | amide | | | | | | | | | | |
| Example 25 | PY185 | 50 | Erucic acid | 21 | 15 | 30 | 75 | 15 | 59 | 90 | 105 | 0.1 | G2 |
| | | | amide | | | | | | | | | | |
| Example 26 | PY185 | 50 | Erucic acid | 21 | 15 | 30 | 75 | 15 | 59 | 90 | 105 | 0.03 | G2 |
| | | | amide | | | | | | | | | | |
| Example 27 | PY185 | 50 | Erucic acid | 21 | 15 | 30 | 75 | 15 | 59 | 90 | 105 | 0.11 | G2.5 |
| | | | amide | | | | | | | | | | |
| Example 28 | PY185 | 50 | Erucic acid | 21 | 15 | 30 | 75 | 15 | 59 | 90 | 105 | 0.02 | G2.5 |
| | | | amide | | | | | | | | | | |
| Comparative | — | — | — | — | — | — | — | 15 | 59 | 90 | — | | G5 |
| Example 1 | | | | | | | | | | | | | |
| Comparative | PY185 | 50 | Erucic acid | 21 | 5 | 10 | 80 | 15 | 59 | 70 | 110 | 0.05 | G5 |
| Example 2 | | | amide | | | | | | | | | | |
| Comparative | PY185 | 50 | Erucic acid | 21 | 5 | 10 | 80 | 15 | 59 | 120 | 110 | 0.07 | G4 |
| Example 3 | | | amide | | | | | | | | | | |

The above results tell that the present examples further suppress the transferability to a thick recording medium, compared to comparative examples.

The present exemplary embodiment includes the following aspects.

(((1)))

A manufacturing method of a resin particle dispersion comprising: (A) melt mixing of melting and mixing a resin mixture containing a resin, a pigment having an isoindoline skeleton, and a hydrophobic lubricant to obtain a molten mixture; and

(B) emulsification of adding a surfactant and a basic compound to the molten mixture and adding an aqueous medium while applying shearing force in a range of Tm<Te<(Tm+30° C.) to melt and emulsify the molten mixture where Tm represents a softening temperature of the hydrophobic lubricant and Te represents an emulsification temperature.

(((2)))

The manufacturing method of a resin particle dispersion according to (((1))), wherein the resin is a polyester resin.

(((3)))

The manufacturing method of a resin particle dispersion according to (((2))), wherein an acid value of the polyester resin is 10 mgKOH or more and 40 mgKOH or less.

(((4)))

The manufacturing method of a resin particle dispersion according to any one of (((1))) to (((3))), wherein the softening temperature of the hydrophobic lubricant is 60° C. or higher and 100° C. or lower.

(((5)))

The manufacturing method of a resin particle dispersion according to any one of (((1)) to (((4))), wherein a difference between the softening temperature of the hydrophobic lubricant and a softening temperature of the resin is 5° C. or higher and 50° ° C. or lower.

(((6)))

The manufacturing method of a resin particle dispersion according to any one of (((1))) to (((5))), wherein the hydrophobic lubricant is a lubricant having a long hydrocarbon chain.

(((7)))

The manufacturing method of a resin particle dispersion according to (((6))), wherein the number of carbon atoms of the hydrocarbon chain of the lubricant having a long hydrocarbon chain is 10 or more and 30 or less.

(((8)))

The manufacturing method of a resin particle dispersion according to any one of (((1))) to (((7))), wherein an amount of the hydrophobic lubricant is 10% by mass or more and 50% by mass or less with respect to the pigment.

(((9)))

The manufacturing method of a resin particle dispersion according to any one of (((1))) to (((8))), wherein the shearing force applied per 1 kg of the molten mixture to which the surfactant and the basic compound are added is 0.03 kW·h or more and 0.10 KW·h or less.

(((10)))

A manufacturing method of an electrostatic charge image developing toner comprising: aggregating at least resin particles in a dispersion containing the resin particles in the resin particle dispersion obtained by the manufacturing method of a resin particle dispersion according to any one of (((1))) to ((9))) to form aggregated particles; and coalescing the aggregated particles by heating an aggregated particle dispersion containing the aggregated particles dispersed to form toner particles.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of a resin particle dispersion, comprising:
(A) melt mixing of melting and mixing a resin mixture containing a resin, a pigment having an isoindoline skeleton, and a hydrophobic lubricant to obtain a molten mixture; and
(B) emulsification of adding a surfactant and a basic compound to the molten mixture and adding an aqueous medium while applying shearing force in a range of Tm<Te<(Tm+30° C.) to melt and emulsify the molten mixture where Tm represents a softening temperature of the hydrophobic lubricant and Te represents an emulsification temperature.

2. The manufacturing method of a resin particle dispersion according to claim 1,
wherein the resin is a polyester resin.

3. The manufacturing method of a resin particle dispersion according to claim 2,
wherein an acid value of the polyester resin is 10 mgKOH or more and 40 mgKOH or less.

4. The manufacturing method of a resin particle dispersion according to claim 1,
wherein the softening temperature of the hydrophobic lubricant is 60° C. or higher and 100° C. or lower.

5. The manufacturing method of a resin particle dispersion according to claim 1,
wherein a difference between the softening temperature of the hydrophobic lubricant and a softening temperature of the resin is 5° C. or higher and 50° C. or lower.

6. The manufacturing method of a resin particle dispersion according to claim 1,
wherein the hydrophobic lubricant is a lubricant having a long hydrocarbon chain.

7. The manufacturing method of a resin particle dispersion according to claim 6,
wherein the number of carbon atoms of the hydrocarbon chain of the lubricant having a long hydrocarbon chain is 10 or more and 30 or less.

8. The manufacturing method of a resin particle dispersion according to claim 1,
wherein an amount of the hydrophobic lubricant is 10% by mass or more and 50% by mass or less with respect to the pigment.

9. The manufacturing method of a resin particle dispersion according to claim 1,
wherein the shearing force applied per 1 kg of the molten mixture to which the surfactant and the basic compound are added is 0.03 kW·h or more and 0.10 kW·h or less.

10. A manufacturing method of an electrostatic charge image developing toner, comprising:
aggregating at least resin particles in a dispersion containing the resin particles in the resin particle dispersion obtained by the manufacturing method of a resin particle dispersion according to claim 1 to form aggregated particles; and
coalescing the aggregated particles by heating an aggregated particle dispersion containing the aggregated particles dispersed to form toner particles.

11. A manufacturing method of an electrostatic charge image developing toner, comprising:
aggregating at least resin particles in a dispersion containing the resin particles in the resin particle dispersion obtained by the manufacturing method of a resin particle dispersion according to claim 2 to form aggregated particles; and
coalescing the aggregated particles by heating an aggregated particle dispersion containing the aggregated particles dispersed to form toner particles.

12. A manufacturing method of an electrostatic charge image developing toner, comprising:
aggregating at least resin particles in a dispersion containing the resin particles in the resin particle dispersion obtained by the manufacturing method of a resin particle dispersion according to claim 3 to form aggregated particles; and
coalescing the aggregated particles by heating an aggregated particle dispersion containing the aggregated particles dispersed to form toner particles.

13. A manufacturing method of an electrostatic charge image developing toner, comprising:
aggregating at least resin particles in a dispersion containing the resin particles in the resin particle dispersion obtained by the manufacturing method of a resin particle dispersion according to claim 4 to form aggregated particles; and
coalescing the aggregated particles by heating an aggregated particle dispersion containing the aggregated particles dispersed to form toner particles.

14. A manufacturing method of an electrostatic charge image developing toner, comprising:
aggregating at least resin particles in a dispersion containing the resin particles in the resin particle dispersion obtained by the manufacturing method of a resin particle dispersion according to claim 5 to form aggregated particles; and
coalescing the aggregated particles by heating an aggregated particle dispersion containing the aggregated particles dispersed to form toner particles.

15. A manufacturing method of an electrostatic charge image developing toner, comprising:
aggregating at least resin particles in a dispersion containing the resin particles in the resin particle dispersion obtained by the manufacturing method of a resin particle dispersion according to claim 6 to form aggregated particles; and
coalescing the aggregated particles by heating an aggregated particle dispersion containing the aggregated particles dispersed to form toner particles.

16. A manufacturing method of an electrostatic charge image developing toner, comprising:
aggregating at least resin particles in a dispersion containing the resin particles in the resin particle dispersion obtained by the manufacturing method of a resin particle dispersion according to claim 7 to form aggregated particles; and
coalescing the aggregated particles by heating an aggregated particle dispersion containing the aggregated particles dispersed to form toner particles.

17. A manufacturing method of an electrostatic charge image developing toner, comprising:
aggregating at least resin particles in a dispersion containing the resin particles in the resin particle dispersion obtained by the manufacturing method of a resin particle dispersion according to claim 8 to form aggregated particles; and
coalescing the aggregated particles by heating an aggregated particle dispersion containing the aggregated particles dispersed to form toner particles.

18. A manufacturing method of an electrostatic charge image developing toner, comprising:
aggregating at least resin particles in a dispersion containing the resin particles in the resin particle dispersion obtained by the manufacturing method of a resin particle dispersion according to claim 9 to form aggregated particles; and
coalescing the aggregated particles by heating an aggregated particle dispersion containing the aggregated particles dispersed to form toner particles.
